(19) United States
(12) Patent Application Publication
(10) Pub. No.: US 2010/0276063 A1
(43) Pub. Date: Nov. 4, 2010

(54) METHODS OF MANUFACTURING QUADRUPOLE MASS FILTERS

(76) Inventor: Henry Hoang Xuan Bui, Hayward, CA (US)

Correspondence Address: NATHANIEL TUE TRAN, 42065 ZEVO DRIVE, SUITE #9, TEMECULA, CA, 92590, US

(21) Appl. No.: 12/772,993

(22) Filed: May 3, 2010

Related U.S. Application Data
(60) Provisional application No. 61/175,009, filed on May 2, 2009.

(51) Int. Cl. B29C 65/48; B29C 65/56; B23P 17/00; B23P 11/00

(52) U.S. Cl. 156/91; 156/60; 29/412; 29/464

(57) ABSTRACT

This invention teaches a method to manufacture a mass filter or ion trap especially a quadrupole type with hyperbolic-shaped poles. The method uses at least one outer bracket to hold and align electrodes, poles or rods in place while fixing these rods to holders by adhesive and fastener. Then the bracket(s) can be removed without damaging the critical parts of this newly assembled quadrupole. A method for manufacturing the brackets is also taught to show the main advantage of this manufacturing method.

### CROSS-REFERENCE TO RELATED APPLICATIONS

This application claims priority of provisional patent application U.S. Ser. No. 61/175,009 titled “Methods of Manufacturing Quadrupole Mass Filters” filed May 2, 2009.

### FIELD OF THE INVENTION

This invention is related to mass spectrometer, specifically the manufacturing process for the main analyzer used to differentiate different masses from each other.

### BACKGROUND OF THE INVENTION

Mass filtering analyzers of mass spectrometer typically use an assembly of multiple poles. A physical part of a pole or electrode used in this assembly is hereby referred to as a rod because of its shape. Typically a mass filter has four poles thus the name quadrupole. Each of the pole or rod can be of circular shape like a cylinder or hyperbolic shape. Hyperbolic-shaped quadrupoles yield the best performance in ion transmission because of the nature of the field that it can generate. However, hyperbolic-shaped quadrupoles are much more difficult to make because the precision of its shape, straightness, and symmetry must be extremely high for optimum ion transmission. Typically a quadrupole comprises four rods held together in place by two or more holders. For optimum ion transmission and filtering, these rods need to be in perfect alignment for parallel and symmetry. Thus in addition to making the rod with high precision shape and straightness, the rods have to be assembled together with high precision to yield this perfect symmetry and parallelism.

There are two different existing methods of assembling a quadrupole used as the core of a mass spectrometer. One method described in U.S. Pat. No. 5,389,785 uses high precision holder parts to assemble and hold the rods precisely in their final places. A quadrupole has four rods, and the alignment has a C4 symmetry so 4 sets of identical parts can be made to accomplish this final assembly. Another method described in U.S. Pat. No. 6,926,783 uses a high precision mandrel to align the rods into their final position while gluing them to a set of holders that will hold them in this position when the glue cures. Then the mandrel can be removed after the glue has cured and the rods have settled in their final places.

Problems with Existing Methods:

The first approach of making a multi-pole assembly with high precision parts and interlocking the rods and holders together to create a high precision assembly requires that all parts are made with high degree of precision. This method results in very high cost of manufacturing thus can definitely be improved upon.

The second approach uses a mandrel to align the rods and hold them in place while they are glued to a bracket thus eliminating the needs for making any high precision holders' parts. However this also creates some problems and limitations. The first problem occurs when the mandrel is removed at the end of the assembling process. The removal of the mandrel can cause scratching of the high precision rods' inner surfaces which is extremely undesirable. Any imperfection in the inner surfaces of these rods will impair ion transmission and hinder the mass filter's ability to perform at peak efficiency. Using lubricants to minimize scratching may alleviate part of this problem, but will leave undesirable residues on the entire assembly. The second problem is in making the mandrel. This is an extremely high precision part that must have perfect symmetry in addition to straightness and having the correct shape. For a quadrupole that uses a special hyperbolic shape, it is difficult enough to make one element with this shape to a high degree of precision. A mandrel for a hyperbolic-shaped quadrupole requires that four of these shapes are made in a perfect C4 rotational symmetry which is extremely difficult. While it is only necessary to make one mandrel and use for many quadrupole assemblies, making all the tools and dies necessary to cut one mandrel is still almost as costly as making the tools to make many high precision interlocking brackets. Furthermore, it is a waste to make special tooling that would carve hyperbolic-shape concave surfaces into a mandrel just to manufacture one. As a result, this manufacturing method is costly and can be improved upon.

While the interlocking holder from the first approach can hold the rods together to withstand some shocks and sudden thermal expansions, the glue from the second approach can not. Since the rods are made of conducting material and the holders are made of none conducting material, they usually have very distinct thermal expansion and conductivity properties. There have been quite a few incidents when these rods become loose from their holders and must be replaced. This presents a low quality issue with the second manufacturing method.

While the interlocking parts can hold the rods tightly together under compression pressure; there are still tiny space gaps possible where a rod touches a holder's part. This space gap can result in space charge problem which builds up over time and eventually compromises the performance of the mass filter.

### SUMMARY OF THE INVENTION

The main object of this invention is to teach a simple and economical method of assembling quadrupole type mass filters using an outer high precision alignment bracket assembly to yield perfect and reproducible rods' placement every single time without touching the inner working surface of the quadrupoles' elements.

Another object of this invention is to teach a method for making the alignment bracket casing for use in the assembling process. Two L-shaped brackets which form an alignment bracket assembly can be made by producing a single elongated piece which is then cut into at least four pieces. This automatically produces a C4 rotational symmetry when four pieces are put together in order for them to fit perfectly to form a square.

A further object of the invention is to provide needed support for the rods within a quadrupole so they can withstand shocks, vibrations, and rapid change in temperature that results in fast expansion and contraction of rods vs. holders that can dislodge the adhesive compound bonding the two parts together. This is accomplished by using fasteners such as screws to tie rods and holders together. Bonding of glue is also improved by grating the rods and the holders at the locations where glue will hold them together. Grating can also be made with a locking dovetail pattern that locks dried adhesive into place for much more superior holding.

A further object of the invention is to enable a method that completely fills all the space gaps between rods and holders with adhesive compound to avoid generation of space charge. This is made possible by adding the adhesive to a gap between one rod and one holder, and then tightening the screw that will pull the gap narrower thus squeezing out the glue and filling all the space without trapping air bubble or leaving unfilled spaces.

### BRIEF DESCRIPTION OF THE DRAWINGS

FIG. 1: Illustrates a quadrupole at the final assembling stage when it is ready for the removal of the alignment brackets.

FIG. 2: Illustrates details of all the features for a rod and a holder that enable them to be held together tightly and securely.

FIG. 3: Illustrates how two bracket assemblies can hold and align four rods to make a final quadrupole with the holders omitted.

FIG. 4: Illustrates how two rods are held in place by two L-shaped bracket. If the L-shaped pieces are magnetized and the rods are paramagnetic, then the rods can be held into place for much easier assembling without the help of any thing else.

FIG. 5: Illustrates the top view of how four rods are aligned to a complete bracket assembly. The magnified view clearly shows how a screw can pull a rod in place as the tapper edges center the rod for proper alignment.

FIG. 6: Illustrates how an alignment bracket assembly is made from only one high precision piece and then cut into smaller pieces.

### DETAIL DESCRIPTION OF THE INVENTION

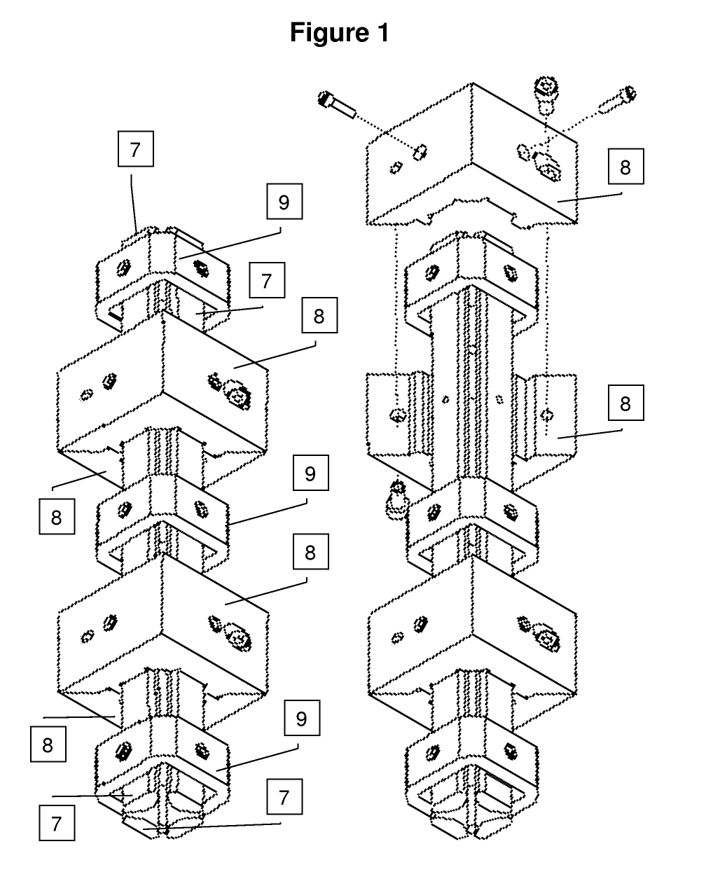

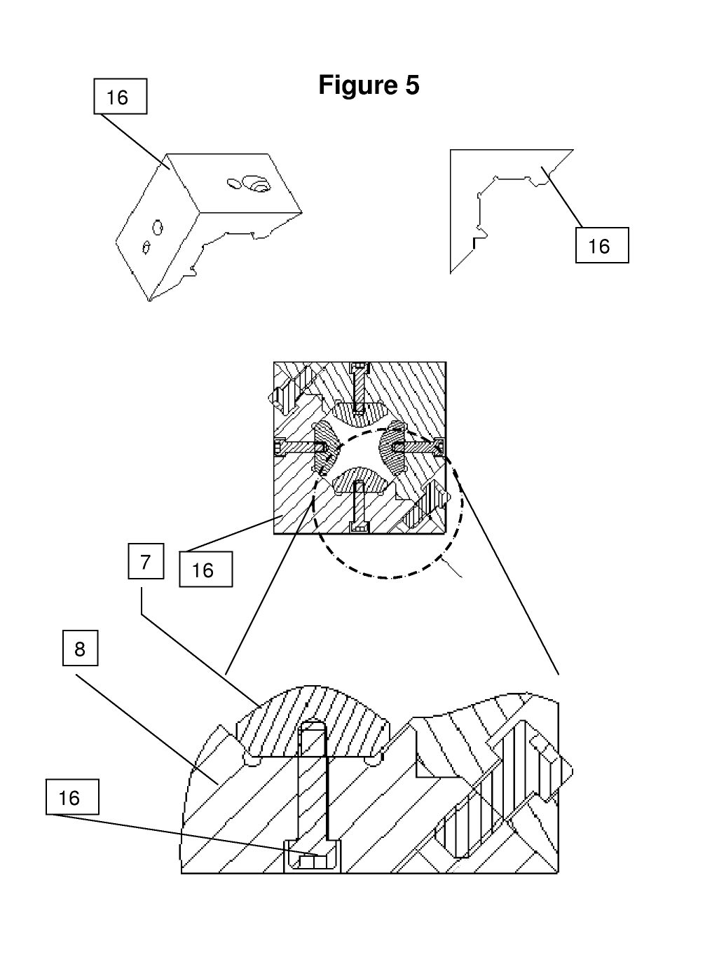

A quadrupole is made by first making four electrodes, poles or rods and then assemble them together as showed in FIG. 1. Only the shape inside the quadrupole is important to the field that will be generated for mass filtering or ion trapping so the outside shape can be flexible. For quadrupoles with hyperbolic-shaped rods, the outside is normally kept flat. In this case the flat back will also be made to have 45 degree taper edges to be used to align the rods using two sets of outer alignment brackets as shown in FIG. 5. Typically, two rods each are mounted together to make one L shape bracket (half a final bracket assembly). Then two of these are put together to put four rods in place preferably holding the rods in vertical position. Then a holder is slipped on to become the center rods' holder. Then another alignment bracket assembly is put in place and the other two holders slipped on from the two ends. Now the screws holding each pair of L-shaped brackets to make the two alignment bracket assemblies are fastened with a preset amount of torque. Then glue is added to fill the space between the rods and the holders. Then all the screws on the four L-shaped brackets are also fastened using equal amount of torque to align the rods into their final positions. Additionally, a screw can be used to fasten each rod and holder together with equal amount of torque.

### Additional Improvements Over Existing Methods:

To simplify the holding process, the alignment brackets can be magnetized and the rods can be made of paramagnetic materials. This allows the brackets to hold the rods in place naturally by magnetic attraction without the help of any fasteners. This will facilitate the process of filling all the spaces between the rods and the holders with adhesive to avoid any gaps that may result in space charge problem. For instance, a rod can be moved with little restriction to open this space gap wider for the addition of glue. This will make sure that there is no air trapped in between any rods and holders points of contact.

To improve the holding integrity of adhesive, grating can be created on the rods and on the holders at the place where they are to be glued together. These grating can be made with locking patterns such as dovetails that will actually hook dried adhesive into place. Furthermore, screws can be added to tie holders and rods together with proper amount of torque without pulling these rods out of alignment. This method is not possible when the rods are aligned around a mandrel because screwing into holders would pull these rods away from the mandrel. In the case of using outer alignment brackets, screwing into holders would further align these rods into their final positions when done with proper amount of torque to avoid bending the rods or the holders. The amount of torque applied to each screw on the same holder should be equal for this purpose.

### Illustrations:

With reference to FIG. 1, a final assembling process of a quadrupole is shown with all four rods (7); two sets of alignment brackets each containing four L-shaped brackets (8); and three holders (9) holding the rods. Each set of alignment bracket can be made of two identical L-shape brackets for easy mounting and assembling. Then these L-shaped brackets can be removed easily without scratching any critical surface of the quadrupole.

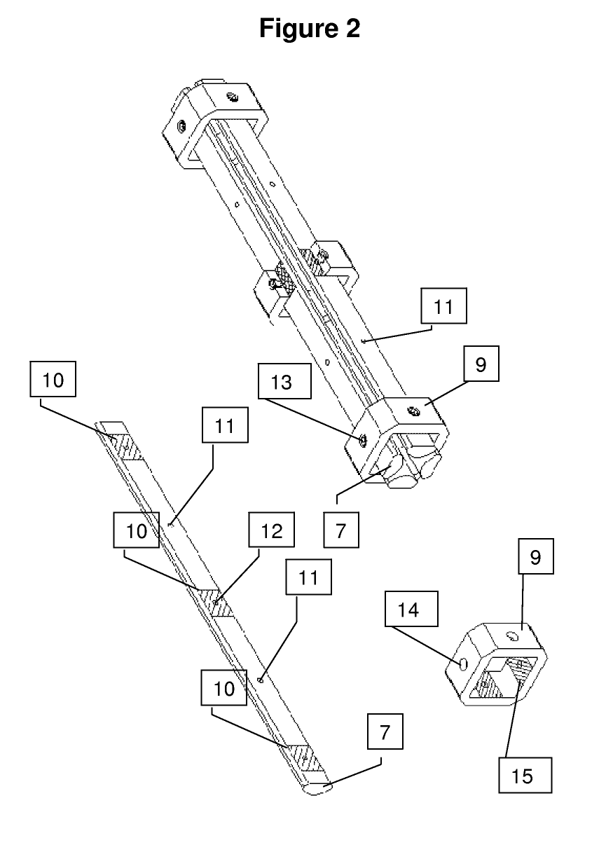

With reference to FIG. 2, each rod (7) has three grated areas (10) so that glue can bond to it and hold it to holder (9) via grated area (15) on this holder much better than just gluing to two flat surfaces. Additionally, there are three threaded screw holes (12) on each rod (7) one of which enables screw (13) to tie holder (9) to rod (7) via this holder's hole (14) more securely. There are also two additional threaded screw holes (11) which are used for holding this rod to an alignment bracket (not shown).

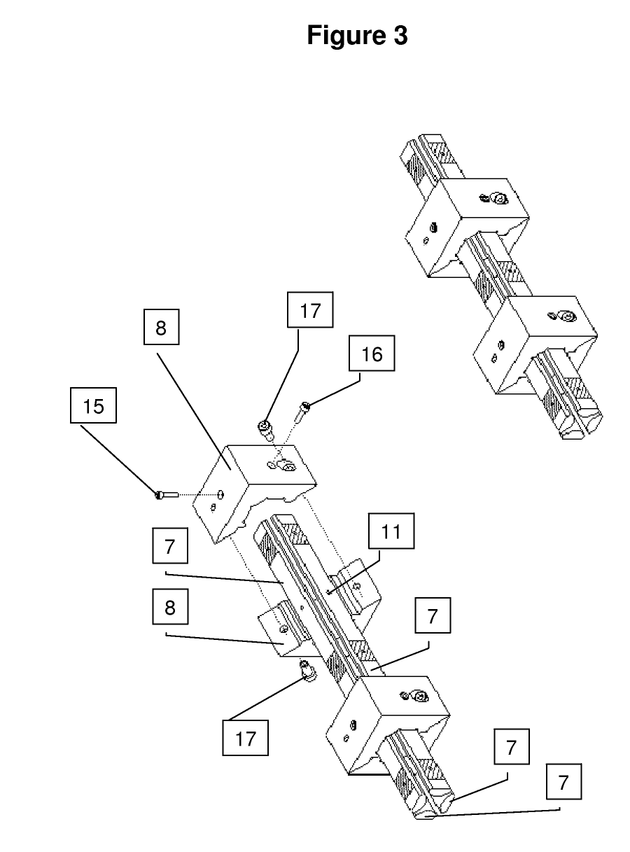

With reference to FIG. 3, two alignment bracket assemblies from four L-shaped brackets (8) are needed to hold and align four rods (7) into their final positions. Each rod is held to an L-shaped bracket by a screw (16) which screws into a hole (11) on each rod (7). Each L-shaped bracket is held to another L-shaped bracket to make an alignment bracket assembly by two screws (17) which can be tighten with a torque-controlled screwdriver for consistent tightness.

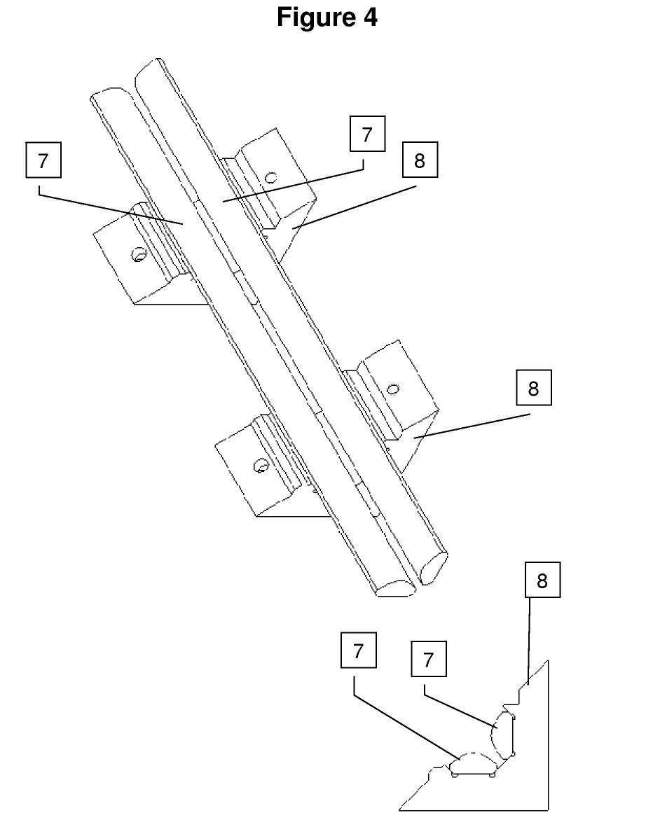

With reference to FIG. 4 which shows how two rods (7) are aligned with two L-shaped brackets. These rods are machined with taper back edges preferably at 45 degrees to the flat edges. The flat edges and the taper edges are machined prior to machining the hyperbolic shape on the opposite site. Preferably, the portion that an L-shaped bracket of an alignment bracket assembly will touch a rod is also the portion that was held during the machining of the hyperbolic shape. This means machining precision is directly transferred to the final assembly. This is how these rods can get their proper alignment when screwed into these brackets with the proper amount of torque. Typically equal amount of torques are apply to all screws holding rods into alignment brackets. A magnified view in FIG. 5 can illustrate how the alignment can be made in greater details.

With reference to FIG. 5 showing the top view of a quadrupole held together by two L-shaped brackets to make an alignment bracket assembly. The magnified top view shows how screw (16) pulls rod (7) into part of an L-shaped bracket of the full bracket assembly so that the rod's two taper edges will align and center it into place. This figure also shows that all the precision surfaces on the L-shaped bracket are straight and flat which are a lot easier to machine than curvy surfaces especially hyperbolic-shaped surfaces.

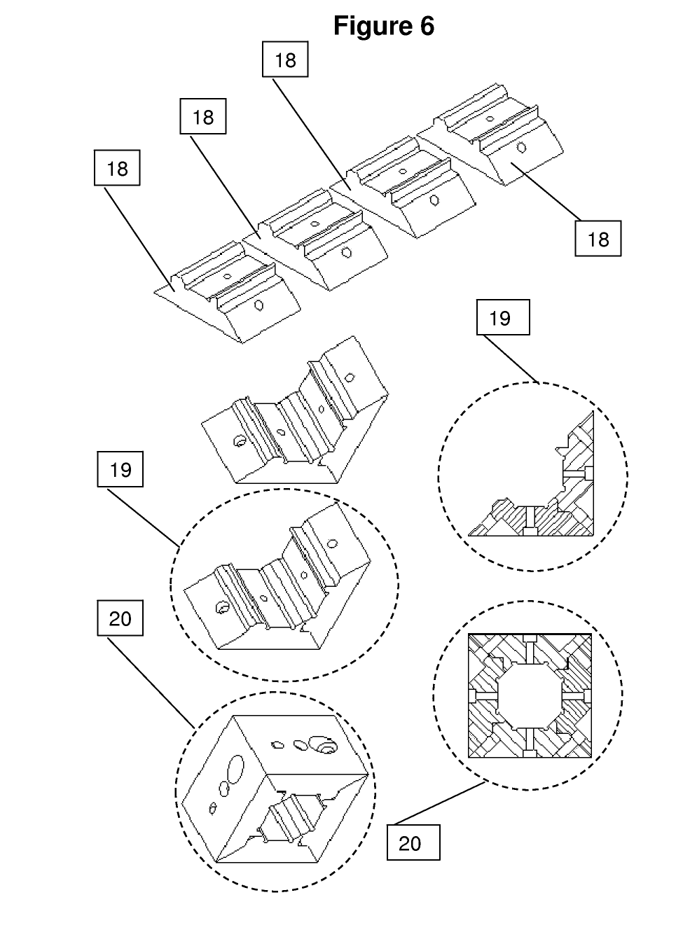

With reference to FIG. 6 which illustrates a method of making an alignment bracket assembly (20) from four single pieces (18). An elongated version of one of these pieces is made and then cut into at least four pieces to make two L-shaped brackets. This elongated piece only has straight edges and flat surfaces that are at 90 degree and 45 degree offsets that need to be machined at high precision thus it is much easier to manufacture than a mandrel with four symmetrical hyperbolic-shaped contours. Then this elongated piece can be cut into at least eight pieces. Typically, every two of these pieces (18) are screwed together permanently to form an L-shaped bracket (19) which is just as good as the L-shaped brackets showed in other figures (8 in other figures). When two L-shaped brackets are screwed together to form a square, the four identical parts automatically create a perfect C4 rotational symmetry. This makes one complete alignment bracket assembly (20).

### Alternatives:

While the preferred method here describes how a quadrupole is assembled using four rods and three holders as the final product, any multi-pole device using a plurality of rods can use the same method with only minor adjustments. For instance, an assembly can have 3, 4, or more rods to generate a field that can encapsulate ions at its center. The device of choice can be used as a mass filter or an ion trap.

While the figures clearly shows that four rods are aligned by two bracket assemblies while they are glued and screwed onto three holders, variations are possible. The same four rods can be aligned by one long bracket assembly in the middle with only two holders holding the rods together.

### DESCRIPTION OF THE PREFERRED EMBODIMENT

A first preferred embodiment of this invention is the use of alignment brackets that touch only the parts not used in generating a field for mass filtering to perform the alignment process. This preserves the integrity of the surface and shape of all important surfaces.

A second preferred embodiment of this invention is the enablement of using fastener such as screws to hold rods and holders together. This is made possible when the alignment bracket is outside the rods thus the pulling forces on these holding screws will not interfere with the alignment, but instead help achieve proper final alignment.

A third preferred embodiment of this invention is the much easier process of manufacturing alignment brackets by making a single elongated piece, cutting into shorter pieces, and assembling them together to form one or more alignment bracket assemblies. While the more complex L-shaped version can be made as one piece, using two smaller pieces to make an L-shaped bracket is much easier especially to achieve perfect C4 rotational symmetry.

A fourth preferred embodiment of this invention is the magnetization of any parts or the entire alignment bracket assembly. When a magnetized bracket is used, it is much simpler to hold paramagnetic rods into places allowing more freedom of movements for easy mounting and gluing.

I claim:

1. A method of manufacturing a mass filter comprises the steps of:
a) providing at least one outer alignment bracket to hold a plurality of rods into place while they are being glued to at least one holder;
b) aligning said bracket and said plurality of rods together using a screw between each rod and said bracket; and,
c) gluing each rod to a holder by an adhesive.

2. The method of claim 1 further comprises the step of:
tying each rod to said holder by a fastener.

3. The method of claim 1 wherein a grating surface is created on the surface of at least one rod to enable better holding by said adhesive.

4. The method of claim 1 wherein a grating surface is created on the surface of said holder to enable better holding by said adhesive.

5. The method of claim 1 further comprises the step of:
gluing each rod to a second holder.

6. The method of claim 1 wherein said plurality of rods each possesses a hyperbolic shape.

7. The method of claim 3 wherein said grating surface contains a dovetail locking pattern to hook said adhesive.

8. The method of claim 4 wherein said grating surface contains a dovetail locking pattern to hook said adhesive.

9. A method of manufacturing a quadrupole comprises the steps of:
a) machining an elongated piece;
b) cutting said elongated piece into at least four pieces;
c) pairing every two of said four pieces together to make two L-shaped brackets;
d) pairing said two L-shaped brackets together to make an alignment bracket assembly; and,
e) using said alignment bracket assembly to assemble a quadrupole.

10. The method of claim 9 wherein said alignment bracket assembly is magnetized.

11. The method of claim 10 wherein at least one rod used in said quadrupole is made of a paramagnetic material.
